(19) United States
(12) Patent Application Publication
(10) Pub. No.: US 2025/0390669 A1
(43) Pub. Date: Dec. 25, 2025

(54) AUTOMATICALLY GENERATING A PROMPT FOR A GENERATIVE MODEL BASED ON RECEIVING A SELECTION OF A USER ROLE

(71) Applicant: Mango Technologies, Inc. DBA ClickUp, San Diego, CA (US)

(72) Inventors: Hariharan Rajagopalan, Milpitas, CA (US); Josh West, Oakland, CA (US); Yuxiang Kou, Mountain View, CA (US); Erich Elendt, Toronto (CA)

(21) Appl. No.: 18/974,253

(22) Filed: Dec. 9, 2024

Related U.S. Application Data
(60) Provisional application No. 63/661,855, filed on Jun. 19, 2024.

(51) Int. Cl. G06F 40/186; G06F 16/335; G06F 40/103

(52) U.S. Cl. CPC G06F 40/186; G06F 16/337; G06F 40/103

(57) ABSTRACT

A task management system stores different types of content items, such as tasks, data objects, or interactions with tasks. The task management system also allows a user to leverage a generative model to generate a content item, such as a task. To simplify generation of a content item, the user identifies the user's role relative to the content item. Based on the role, the task management system selects a set of templates associated with the role, and the user selects a template. The task management system prompts the user to provide values for different fields included in the selected template and to provide a tone of the content item. Based on the provided values, the tone, and output formatting instructions associated with the selected template, the task management system generates a prompt for the generative model and applies the generative model to the prompt to generate the content item.

### CROSS REFERENCE TO RELATED APPLICATION

This application claims the benefit of U.S. Provisional Application No. 63/661,855, filed Jun. 19, 2024, which is incorporated by reference in its entirety.

### BACKGROUND

Increasingly, users leverage generative models to simplify creation of various content. For example, a user provides a prompt to a large language model to generate a document or computer executable instructions based on the received prompt. Different generative models are available to users, and generative models may be trained or tuned to generate specific outputs based on a prompt received from a user.

However, accuracy of content generated by a generative model depends on the prompt provided to the generative model. While this provides flexibility in both content and formatting of content generated by a generative model, limited information is available to users for information to include in a prompt for a generative model and how information included in a prompt affects the content generated by the generative model. Additionally, there may be variations in content generated by different generative models in response to a prompt, creating additional complexity for a user based on which generative model is being used for content generation. Further, many text based generative models, such as large language models, generate plain text output, so users often reformat the plain text generated into different or specific formats, increasing interaction by the user with an online system to refine content generated by a generative model into a suitable format.

### SUMMARY

In accordance with one or more aspects of the disclosure, a task management system stores different types of content items, such as tasks, data objects, or interactions with tasks. Additionally, the task management system allows a user to create content items that are maintained by the task management system and may be distributed to other sources. For a user to create a content item, the task management system receives a request from the user to create a content item, such as a task or a document. In some embodiments, the request specifies a type of the content item to be created. Example types of a content item include: a document, a task, or another data object. The request 405 includes an identifier of the user in various embodiments.

To simplify creation of the content item for the user, the task management system applies one or more generative models, such as large language models (LLMs), to data received from the user after the request to create the content item. Using the one or more generative models to generate the content item reduces an amount of data for the user to provide to the task management system for creating the content item. In various embodiments, a generative model is a generative pre-trained transformer model (GPT) in various embodiments. The generative model generates text in response to a text prompt in various embodiments. During a pre-training process, the generative model is applied to a large text corpus to learn relationships between different portions of text (e.g., words, phrases) and subsequently leverages the learned relationships to generate text output in response to receiving a text prompt as input in various embodiments. Applying a pre-trained generative model to a text prompt allows the task management system to leverage relationships between different text (or images) the generative model learned through application to a text corpus (or image corpus) including a larger amount of data and more varied data than maintained by the task management system when generating a content item.

While applying a generative model to data provided by the user simplifies creation of a content item, data included by the user in a prompt to which the generative model is applied affects data included in the content item. Inclusion or omission of specific information from the prompt affects the accuracy of the generated content item for the user's purpose. Variations between the generated content item and the user's purpose are more likely to occur when the user provides limited data for creating the content item to the task management system.

To simplify generation of the prompt to which the generative model is applied, and to increase an accuracy of the content item generated by the generative model being for the user, the task management system receives a selection of a role of the user relative to the content item. In various embodiments, a role specifies a characteristic of an audience of users viewing the content item or specifies a category of information to include in the content item. Other information may be identified by a role in various embodiments. For example, a role identifies the content item as relating to technical implementation, while another role identifies the content item as relating to marketing or sales. In some embodiments, the task management system receives a selection of a role from a set of roles presented to the user via a creation interface. Different sets of roles may be associated with different users, so the user 400 may be presented with a different set of roles than another user.

Each role is associated with one or more templates by the task management system. Different templates correspond to different types of data included in the content item. Further, different templates cause inclusion of different data in the content item or cause presentation of data in different formats by the content item. In various embodiments, the task management system stores an identifier of a role and stores associations between the identifier of the role and one or more templates to maintain relationships between templates and roles. In response to receiving the selection of the role from the user, the task management system retrieves a set of templates associated with the selected template and presents identifiers of various templates of the set of templates to the user. An identifier of a template may be a name of the template, a description of the template, or other information capable of uniquely identifying a template to the user. However, in some embodiments, the task management system retrieves templates stored by the task management system and presents corresponding identifiers of the templates in response to receiving the request to create the content item without receiving a selection of a role from the user.

Each template includes one or more fields. Each field corresponds to a type of data presented by a content item based on the template or corresponds to a type of data relevant to the content item based on the template. For example, a template is a product listing, with different fields associated with the product listing identifying different attributes of a product. As another example, a template is a technical specification, with different fields associated with the technical specification identifying different features of a product. In another example, a template is a proposal, with different fields associated with the proposal identifying a budget for the proposal, a timeline for the proposal, one or more keywords for the proposal, or other information about the proposal.

Additionally, each template includes one more output formatting instructions. The output formatting instructions specify a format in which content based on the template is presented. In various embodiments, outputting instructions specify one or more formats in which values for fields included in the template are displayed by a content item based on the template. For example, output formatting instructions specify a content item presents data as a table, and identifies fields associated with the type of content associated with different locations within the table. As another example, output formatting instructions specify paragraph formatting, font formatting, or other visual features of a document, as well as identify positions in the document corresponding to fields associated with the type of content.

The task management system receives a selection of a template from the user. For example, a user selects an identifier of a template to select the template via a creation interface. In response to receiving the selection of the template from the user, the task management system generates a form including the fields included in the selected template and having an interface element associated with each field. Generating the form based on the selected template allows the task management system to reduce a number of inputs from the user to provide information for generating the content item. The form 430 provides the user 400 with a structured interface that identifies specific data via the fields for optimally generating the content item, rather than have the user 400 provide unstructured text for the content item to the task management system 130.

Additionally, the creation interface includes one or more inputs for the user to specify a tone or a creativity level of the content item based on the values of the fields associated with the selected type of content. In various embodiments, the form includes fields for a tone or for a creativity level of the content item. In other embodiments, the task management system obtains a tone, or a creativity level, for the content item from a user input to a creation interface or from an interaction by the user with the creation interface in various embodiments. For example, the creation interface presents a tone selection element where a user selects a tone from a group of candidate tones. The tone affects words or phrases included in generated content, as well as punctuation in generated content, which affects how other users perceive the generated content item when reviewing. Example tones include: professional, straightforward, optimistic, inspirational, casual, confident, friendly, encouraging, and humorous.

The creativity level specifies an amount of additional information that is not directly related to the values for the fields included in the selected template 425 that the generative model includes in the content item. In various embodiments, the user selects the creativity level from a set of creativity levels. For example, the user selects one of high creativity, medium creativity, and low creativity as the creativity level. High creativity includes a greater amount of additional information other than the values for the fields included in the selected template in the content item, while low creativity includes less additional information other than the values for the fields included in the selected template in the content item.

In some embodiments, the task management system obtains the tone for the content item based at least in part on one or more additional content items associated with the user. For example, the task management system receives a tone from the user and augments the received tone with one or more additional content items created by the user (or otherwise associated with the user). Alternatively, the task management system obtains the tone by selecting additional content items rather than receiving the tone from the user. Additional content items may similarly be leveraged to determine the creativity level for the content item. For example, the task management system generates an embedding for the content item being created based on the values for the fields included in the template received via the form and selects additional content items previously created by the user that have embeddings with at least a threshold measure of similarity (e.g., cosine similarity, dot product) to the embedding for the content item being created. For example, the task management system generates an embedding for the content item being created based on the values for the fields included in the template and selects additional content items previously created by the user that have embeddings with at least a threshold measure of similarity (e.g., cosine similarity, dot product) to the embedding for the content item being created. As another example, the task management system selects additional content items previously created by the user and included in a common list or a common workspace as the content item or having one or more other common attributes with the content item to be created. Selecting additional content items created by the user (or otherwise associated with the user) allows the task management system to account for a writing style or preferences of the user when generating the content item so a generated content item appears stylistically and thematically consistent with other content items generated by the user.

In some embodiments, the task management system accounts for recency of content items previously created by the user when selecting additional content items. This biases selection of additional content items towards content items more recently created by the user in various embodiments. For example, the task management system selects content items having one or more attributes matching attributes from the values for the fields included in the selected template received via the form and that were created by the user within a threshold amount of time from a time when the task management system received the request to create the content item. As another example, the task management system ranks content items previously created by the user based on their recency relative to the item when the task management system received the request to create the content item, with more recent content items having higher positions in the ranking, and selects content items having at least a threshold position in the ranking. In some embodiments, the task management system maintains one or more example content items associated with the user or associated with an entity associated with the user that the task management system selects as additional content items. Maintaining additional content items associated with the user or with an entity associated with the user allows the user or the entity associated with the user to specify specific example content items for obtaining the tone (or the creativity level) of the content item.

Based on the values for the fields included in the selected template received from the user and the tone for the content item (as well as the creativity level, if specified), the task management system generates a prompt for a generative model, such as a large language model (LLM). The prompt includes identifiers of each field included in the selected template and a corresponding value for each field received from the user, the tone (including one or more additional content items previously created by or associated with the user that were selected), and the output formatting instructions included in the selected template, as well as the creativity level of the content item, if specified. For example, the prompt includes a name (or other identifier) of a field from the selected template in conjunction with a value for the field from the form, includes the output formatting instructions from the selected template, and includes the tone for the content item (and includes the creativity level for the content item, if specified). The task management system applies the generative model to the generated prompt, which generates a content item based on the prompt and relationships between portions of text that the generative model learned through a pre-training process.

The generated content item presents the values received from the user for the fields associated with the selected template based on the output formatting instructions included in the selected template and the tone (and creativity level) included in the prompt. Including the output formatting instructions in the prompt customizes the format with which the content item presents values for the fields based on the selected template, minimizing subsequent modifications to formatting of the content item by the user for subsequent use and conserving computational resources subsequently expended by the task management system for modifying the content item based on inputs received from the user after generation of the content item. For example, the output formatting instructions specify positions for headings in the content item, values of fields included in different headings or in other locations within the content item, as well as other visual features of the content item.

Hence, the task management system leverages a template selected by the user to generate a form that prompts the user to provide values for specific fields associated with the selected template. Identifying fields via the selected template identifies the most relevant information for generating the content item to the user. Similarly, the output formatting instructions included in the selected template allow the task management system to further simplify generation of the content item by reducing a likelihood of the user subsequently reformatting a content item generated by a generative model based on the values for the fields associated with the selected template.

### BRIEF DESCRIPTION OF THE DRAWINGS

FIG. 1 illustrates an example system environment for a task management system, in accordance with one or more embodiments.

FIG. 2 illustrates an example system architecture for a task management system, in accordance with one or more embodiments.

FIG. 3 illustrates a flowchart of a method for generating a prompt for a generative model based on a user selection of a role associated with a content item, in accordance with one or more embodiments.

FIG. 4 illustrates an interaction diagram of a method for generating a prompt for a generative model based on user selection of a role associated with a content item, in accordance with one or more embodiments.

### DETAILED DESCRIPTION

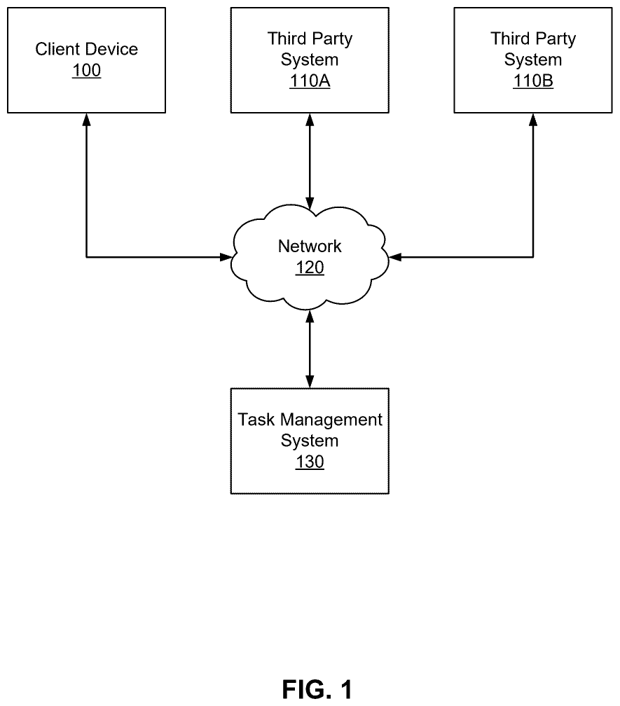

FIG. 1 illustrates an example system environment for a task management system 130, in accordance with one or more embodiments. The system environment illustrated in FIG. 1 includes a client device 100, one or more third party systems 110A, 110B (also referred to individually and collectively using reference number 110), a network 120, and a task management system 130. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

While FIG. 1 shows a single client device 100 for purposes of illustration, any number of client devices 100 may be included in the system environment. As such, there may be more than one client device 100 in various embodiments. The client device 100 is a device through which a user may interact with one or more third party systems 110 or with the task management system 130. The client device 100 can be a personal or mobile computing device, such as a smartphone, a tablet, a laptop computer, or desktop computer. In some embodiments, the client device 100 executes a task management application that uses an application programming interface (API) to communicate with the task management system 130.

Through interaction with the client device 100, a user creates one or more tasks stored by the task management system 130 via the task management application, with each task corresponding to one or more actions to be performed and a performing user to perform the one or more actions. The performing user may be the user who created the task or may be a different user. Additionally, the user may specify one or more attributes of a task. Example attributes of a task include a status of the task, a due date for the task, a priority level of the task, a resource allocation (e.g., a budget) for performing the task, one or more comments about the task, or other information relevant to performing an action corresponding to the task.

In various embodiments, the task management application executing on the client device 100 presents a workflow management interface to the user. The workflow management interface is a user interface that receives input from the user to identify or create tasks, generate a list of related tasks, generate a hierarchy of tasks, associate a task with a performing user, modify one or more attributes of a task, or perform other interactions affecting one or more tasks. In various embodiments, the workflow management interface allows the user to search for tasks satisfying one or more attributes that are identified by task management system 130 and accessible to the user. Additionally, the workflow management interface includes one or more messaging elements allowing the user to provide messages for transmission to one or more receiving users of the task management system 130.

The client device 100 may receive additional content from the task management system 130 to present to a customer. For example, the client device 100 may receive one or more messages for presentation to the user. As another example, the client device receives notifications from the task management system 130 and presents the notifications to the customer. A notification may indicate a change to an attribute of a task associated with the user (e.g., a change in a status of the task).

In some embodiments, the task management application also generates and presents a communication interface to the user that allows the customer to communicate messages to the task management system 130, to a receiving user of the task management system 130, or to a third party system 110. A message may include text data, audio data, image data, video data, or any combination thereof. For example, a message is a text message or a chat message. The client device 100 transmits a message via the network 120 and may receive one or more message via the network 120. In some embodiments, the communication interface may allow the user of the client device 100 and another user to communicate through audio or video communications, such as a phone call, a voice-over-Internet-Protocol call, or a video call.

A third party system 110 is a computing system separate from the task management system 130 that interacts with the task management system 130 or with the client device 100. In various embodiments, different third party systems 110A, 110B provide different types of content to the task management system 130 or to the client device 100. For example, a third party system 110 is an application provider communicating information describing one or more applications for execution by a client device 100 or communicating data to a client device 100 for use by an application executing on the client device 100. In other embodiments, a third party system 110 provides content or other information for presentation via a client device 100. A third party system 110 may also communicate information to the task management system 130, such as files, documents, metadata, or other information to the task management system 130.

The client device 100, the one or more third party systems 110, and the task management system 130 can communicate with each other via the network 120. The network 120 is a collection of computing devices that communicate via wired or wireless connections. The network 120 may include one or more local area networks (LANs) or one or more wide area networks (WANs). The network 120, as referred to herein, is an inclusive term that may refer to any or all of standard layers used to describe a physical or virtual network, such as the physical layer, the data link layer, the network layer, the transport layer, the session layer, the presentation layer, and the application layer. The network 120 may include physical media for communicating data from one computing device to another computing device, such as MPLS lines, fiber optic cables, cellular connections (e.g., 3G, 4G, or 5G spectra), or satellites. The network 120 also may use networking protocols, such as TCP/IP, HTTP, SSH, SMS, or FTP, to transmit data between computing devices. In some embodiments, the network 120 may include BLUETOOTH® or near-field communication (NFC) technologies or protocols for local communications between computing devices. The network 120 may transmit encrypted or unencrypted data.

The task management system 130 is an online system by which users identify tasks specifying actions to be performed, identify a performing user to perform an action identified by a task, and specify attributes of the task. The task management system 130 maintains associations between users and tasks. For example, the task management system 130 stores an association between a task identifier of a task and one or more user identifiers of users, such as a user who identified the task and one or more performing users associated with the task. The task management system 130 receives modifications to one or more attributes of a task from a user associated with the task, and updates the attributes of the task based on the received modifications. Additionally or alternatively, the task management system 130 may modify one or more attributes of a task based on information describing actions performed by a user. The task management system 130 transmits a notification to a client device 100 of a user associated with a task in response to an attribute of the task being modified, allowing a user associated with the task to remain informed of changes to one or more attributes of the task.

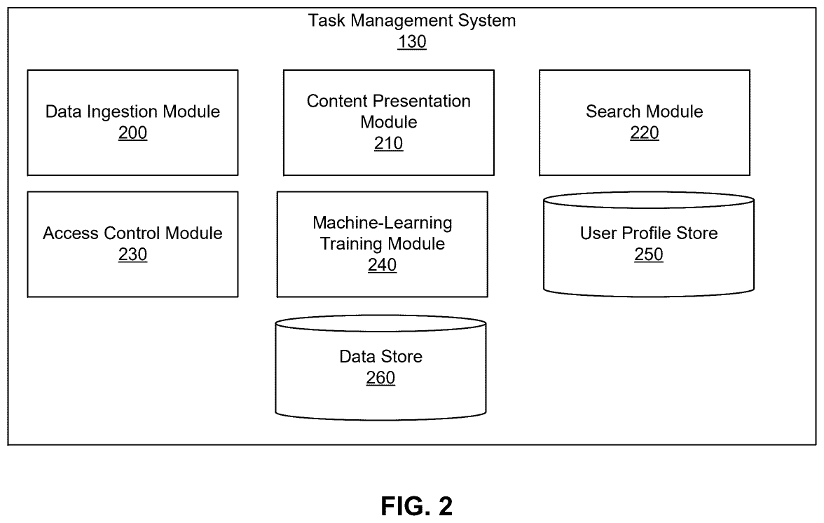

Additionally, the task management system 130 may generate one or more interfaces for a user associated with one or more tasks. For example, an interface identifies tasks associated with a user and identifies at least a set of attributes of the tasks, allowing the user to readily review and identify attributes of different tasks. The interface may identify relationships between tasks or between tasks and one or more sub-tasks of a task identified by a user, allowing a user to visualize relationships between different tasks. Further, the task management system 130 may store files or other data associated with a task or store information from retrieving files or data associated with the task from a third party system 110 to simplify access to data for reviewing or for performing a task for a user. The task management system 130 is described in further detail below in conjunction with FIG. 2.

FIG. 2 illustrates an example system architecture for a task management system 130, in accordance with some embodiments. The system architecture illustrated in FIG. 2 includes a data ingestion module 200, a content presentation module 210, a search module 220, an access control module 230, a machine learning training module 240, a user profile store 250, and a data store 260. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data ingestion module 200 collects data used by the task management system 130 and stores the data in the user profile store. For example, the data ingestion module 200 receives information from a user creating a task, including one or more attributes of a task, or instructions for modifying one or more attributes of a task. Additionally, the data ingestion module 200 receives information from a user including characteristics of a user for inclusion in a corresponding user profile. The data ingestion module 200 may encrypt some or all of the obtained data, such as certain data describing a user.

The data ingestion module 200 also receives data describing relationships between tasks. For example, a user may identify one or more discrete sub-tasks that correspond to different portions of a task. Further, the data ingestion module 200 may receive data describing a hierarchy of tasks. For example, the data ingestion module 200 receives an identifier of a list from a user along with identifiers of one or more tasks to associate with the list. Hence, the list includes one or more tasks, allowing a user to organize related tasks, tasks related to a common objective, or tasks having one or more other common criteria. Additionally hierarchical information may be specified in some embodiments. For example, the data ingestion module 200 receives an identifier of a category and identifiers of one or more lists associated with the category, allowing a user to generate a grouping of lists, and the tasks included in the lists. As further described below, the data ingestion module 200 stores information describing relationships between tasks in the data store 260.

Additionally, the data ingestion module 200 captures interactions by users with tasks and stores the interactions in an interaction log included in the data store 260. In various embodiments, when a user interacts with a task through the task management system 130, the data ingestion module 200 determines an identifier of the user, an identifier of the task with which the user interacted, a time when the interaction occurred, and a description of the interaction by the user with the task. When the interaction with a task modifies an attribute of the task, the description of the interaction by the user includes an identifier of the attribute of the modifier of the task and a modified value of the task. In some embodiments, the description of the interaction includes an indication that the interaction changed at least one attribute of the task. Capturing interactions by users with tasks allows the data ingestion module 200 to generate an interaction log in the data store 260 that may be used to subsequently identify modifications to attributes of a task or a history of how one or more users interacted with a task. This may be leveraged to generate a record of how one or more users interacted with one or more tasks over time.

The content presentation module 210 selects content for presentation to a user and generates one or more interfaces for displaying the content to the user. In various embodiments, the content presentation module 210 receives a request for content from the user including one or more criteria, selects one or more tasks having characteristics satisfying one or more of the criteria, and generates an interface displaying information about the selected one or more tasks to a user. The content presentation module 210 generates instructions for transmission to a client device 100, which executes the instructions to generate an interface presenting the information about the selected one or more tasks. In various embodiments, the request from the user includes display instructions specifying how an interface presents information about the selected one or more tasks. For example, a request specifies a calendar view, so the content presentation module 210 generates an interface displaying information about one or more tasks on a calendar, with the calendar displaying information identifying a task, and one or more characteristics of the task, in a portion of the calendar corresponding to a date associated with the task. As another example, a request includes a specific attribute of a task, and the content presentation module 210 selects tasks having the specific attribute and generates instructions for an interface presenting the selected tasks.

In various embodiments, the content presentation module 210 generates a creation interface that receives input from a user. Subsequently, the content presentation module 210 applies one or more generative models to the received input to create a content item for the user based on the received input. The content item may be a task, a document, a subtask, or another type of data object in various embodiments. The content presentation module 210 generates the creation interface in response to receiving a request for creating a content item from the user via a client device.

In various embodiments, the creation interface receives an input from a user selecting a role of the user relative to the content item. The role may specify a characteristic of an audience of users viewing the content item, specify a category of information to include in the content item, or specify another attribute of the content item or another characteristic of the user (or of additional users). However, other information may be specified by a role in other embodiments. For example, a role identifies the content item as relating to technical implementation, while another role identifies the content item as relating to marketing or sales. The content presentation module 210 maintains a set of roles in various embodiments, with the creation interface displaying the set of roles to the user and receiving a selection of a role from the set.

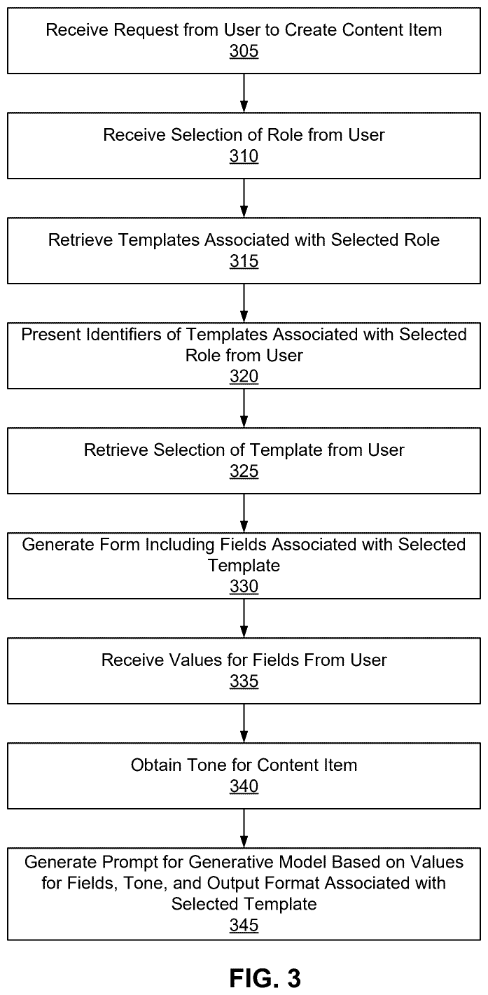

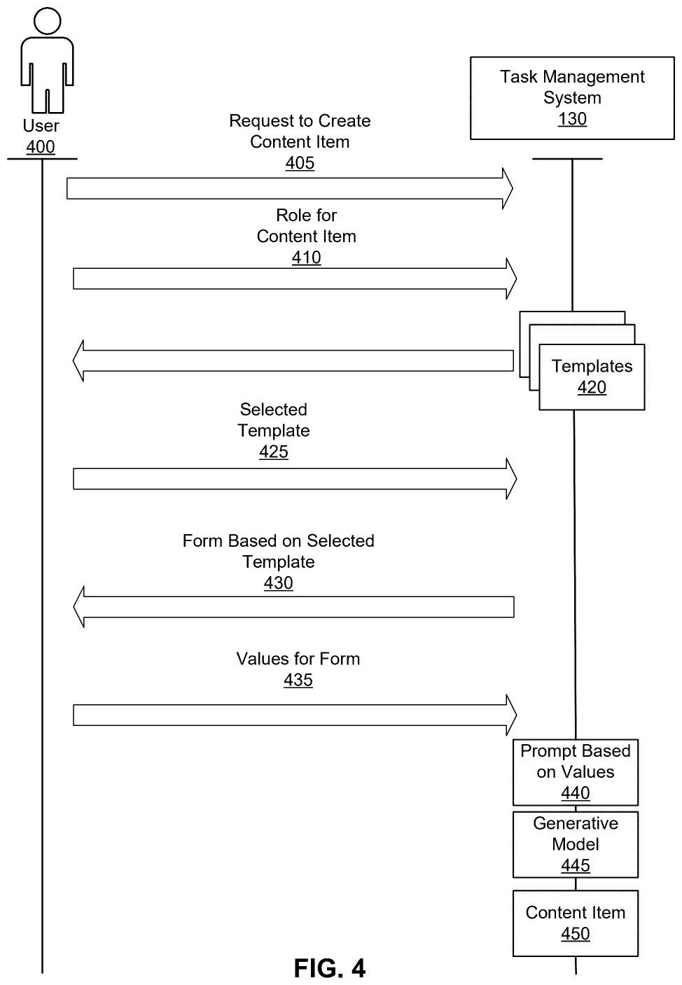

As further described below in conjunction with FIGS. 3 and 4, the content presentation module 210 associates one or more templates with each role. Different templates correspond to different data included in a content items or correspond to different formats for presentation of data by the content item. Maintaining different templates allows the content presentation module 210 to specify different combinations of types of data for inclusion in a content item, as well as different formats for presenting various data in a content item. Templates associated with a role may be manually generated and manually specified in some embodiments. Alternatively, templates associated with a role may be automatically generated by the content presentation module 210 using a clustering model or another model. In various embodiments, the creation interface identifies a set of templates associated with the role selected by the user and receives a selection of a template from the user.

Each template includes one or more fields. Each field corresponds to a type of data presented by a content item based on the template or to a type of data relevant to content based on the template. Additionally, each template includes one or more output formatting instructions. The output formatting instructions specify a format in which a content item based on the template presents different data to the user. In various embodiments, output formatting instructions specify different relative positions of values for different fields included in the template in a content item or specify visual features of how values or other data for various fields are presented in the content item. For example, output formatting instructions in a selected template specify presentation of data by a content item in a table and identifies different locations within the table associated with different fields included in the selected template. As another example, output formatting instructions in a template specify paragraph formatting, font formatting, or other visual features of a document, as well as identify positions in the document corresponding to fields included in the template.

The content presentation module 210 updates the creation interface to display a form including the fields included in the selected template or generates another creation interface including a form including the fields included in the selected template. The form identifies each field associated with the selected template and includes an interface element for each field that receives input from the user specifying a value for the field. The form provides the user with a structured interface identifying specific fields used to generate the content item rather than have the content presentation module 210 receive unstructured text from the user for generating the content item. Identifying different fields for the selected template to the user and receiving values for the fields from the user increases a likelihood of the content presentation module 210 receiving data from the user that is most relevant to generation of a content item for the user.

Additionally, the creation interface includes one or more inputs for the user to specify a tone or a creativity level of the content item. For example, the creation interface presents a tone selection element where a user selects a tone from a group of candidate tones. The selected tone affects inclusion of words or phrases in a generated content item, as well as punctuation used in the generated content item, which affects how other users perceive the content item when reviewing. Hence, the tone modifies choices of text by the generative model, phrases generated by the generative model, punctuation or other style conventions applied by the generative model, or modifies other selection or positioning of text by the generative model. Example tones include: professional, straightforward, optimistic, inspirational, casual, confident, friendly, encouraging, and humorous. However, other values for tone may be maintained by the content presentation module 210 in various embodiments.

The creativity level specifies an amount of additional information included in the generated content item that is not directly related to the values for the fields associated with the selected template. For example, the user selects between high creativity, medium creativity, and low creativity for the creativity level. Different creativity levels include different relative amounts of additional information other than the values for the fields included in the selected template in the content item in the content item.

In some embodiments, as further described below in conjunction with FIGS. 3 and 4, the tone for the content item comprises or includes one or more additional content items created by the user (or otherwise associated with the user) to obtain information about the tone or creativity level of content associated with (or created by) the user. This leverages additional information about a writing style or preferences of the user from the additional content items when generating the content item, so the content item more closely matches a tone or a creativity level of other content form the user. Examples of selecting additional content items are further provided below in conjunction with FIG. 3.

Based on the values for the fields included in the selected template and the tone for the content item (as well as the creativity level, if specified), the content presentation module 210 generates a prompt for a generative model, such as a large language model (LLM). The prompt includes identifiers of each field included in the selected template and corresponding values received for one or more of the fields included in the selected template, the tone (including one or more additional content items previously created by or associated with the user), and the output formatting instructions included in the selected template, as well as the creativity level of the content item, if specified. In some embodiments, additional or alternative information may be included in the prompt.

The content presentation module 210 applies the generative model to the generated prompt. Based on the generated prompt and relationships between portions of text the generative model learned through a pretraining process, the generative model generates the content item. The content item presents the values for the fields associated with the selected template based on the output formatting instructions associated with the selected template and the tone (and creativity level) included in the prompt. Hence, the content presentation module 210 simplifies generation of the prompt for the generative model by providing the user with one or more structured interfaces that identify specific fields of data for optimally generating a content item for a particular purpose indicated by the selected role.

The search module 220 receives a search query from the client device 100 and retrieves search results comprising tasks, or other data objects, with attributes at least partially satisfying the search query. Data objects may be documents, video files, audio files, or other files accessible to the search module 220. A search query is text for a word or set of words that indicate attributes of a task or another data object. In various embodiments, the search module 220 generates a score for each task, or other data object, at least partially satisfying the search query and presents the search results based on their corresponding scores. For example, the search module 220 scores tasks or other data objects based on a measure of relevance of a task or a data object to a search query. For example, the search module 220 applies natural language processing (NLP) techniques to text in the search query to generate a search query embedding representing characteristics of the search query. The search module 220 may use the search query embedding to score candidate items for presentation to a customer (e.g., by comparing a search query embedding to an item embedding).

In some embodiments, a user authorizes the task management system 130 to access information associated with the user and stored by a third party system 110. In various embodiments, the search module 220 stores authentication information for the third party system 110 corresponding to the user in association with an identifier of the user and an identifier of the third party system 110. The authentication information for the third party system 110 may be a combination of a username and password or other authentication information for the user to access the third party system 110. In various embodiments, when the task management system 130 receives a search query from the user, the task management system, through one or more application programming interfaces (APIs), the search module 220 transmits the search query to the third party system 110 and retrieves files or other content items from the third party system 110 that at least partially satisfy the search query. This allows the search module 220 to evaluate both locally stored data in the data store 260 and data maintained by a third party system 110 for the user for search results, allowing the search module 220 to provide search results accounting for data associated with the user from one or more third party systems 110 that the user authorized the task management system 130 to access.

The access control module 230 regulates access to tasks by various users. When a user accesses the task management system 130, the access control module 230 retrieves a user profile of the user from the user profile store 250. Based on one or more permissions in the user profile, the access control module 230 identifies a subset of tasks from the data store 260 for the user based on the one or more permissions. For example, the access control module 230 identifies a subset of tasks that one or more permissions of the user authorize the user to access. Tasks in the subset may be presented to the user or be otherwise accessible to the user, while tasks in the data store 260 and not in the subset are inaccessible to the user. Hence, the access control module 230 to regulate access to stored tasks for different users,

Similarly, for a task, the access control module 230 determines a set of interactions a user is authorized to perform with the task based on one or more permissions in the user profile of the user. For example, a user with a first type of permission is authorized to modify one or more attributes of a task, while another user with a different type of permission is authorized to view the attributes of the task but is unable to modify one or more attributes of the task. As another example, one or more permissions of the user authorize the user to modify a set of attributes of the task, while preventing the user from modifying attributes that are not included in the set. The access control module 230 may receive permissions or modifications to permissions of a user from the user or from another user and store the permissions or the modified permissions in a user profile corresponding to the user. This allows the access control module 230 to regulate types of interactions with a task based on permissions of a user, enabling different users to perform different types of interactions with different tasks.

The machine learning training module 240 trains machine learning models used by the task management system 130. The task management system 130 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 240 generates the set of parameters for a machine learning model by “training” the machine learning model. Once trained, the machine learning model uses the set of parameters to transform inputs into outputs.

The machine learning training module 240 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 240 may apply an iterative process to train a machine learning model whereby the machine learning training module 240 trains the machine learning model on each of the set of training examples. To train a machine learning model based on a training example, the machine learning training module 240 applies the machine learning model to the input data in the training example to generate an output. The machine learning training module 240 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, hinge loss function, and the cross-entropy loss function. The machine learning training module 240 updates the set of parameters for the machine learning model based on the score generated by the loss function. For example, the machine learning training module 240 may apply gradient descent to update the set of parameters.

In various embodiments, the machine learning training module 240 tunes one or more generative models that receive a text prompt and generate content based on the text prompt. A generative model is a large language model (LLM), such as a generative pre-trained transformer model (GPT) in various embodiments. The generative model may generate text in response to a text prompt in various embodiments. Alternatively or additionally, the generative model selects or generates an image in response to a text prompt. A generative model is a model pre-trained on a text corpus including text to output text in response to a text prompt from a user. As another example, a generative model is a generative image model pre-rained on a corpus of images to output an image in response to a received text prompt. Obtaining a pre-trained generative model allows the machine learning training module 240 to leverage relationships between different text (or images) the generative model learned through application to a text corpus or image corpus including a larger amount of data and more varied data than the task management system 130 maintains.

In various embodiments, the machine learning training module 240 generates examples for inclusion in a prompt input to a generative model. An example includes an input to the generative model and an expected output in response to the input. For example, an example includes input text and output text along with formatting instructions for the output text. When applying a generative model to input, the task management system 130 (e.g., the content presentation module 210) generates a prompt for the generative model that includes the input and one or more examples generated by the machine learning training module 240. This allows the example included in the prompt to specify a format or content of the output of the generative model based on the input. In some embodiments, the machine learning training module 240 generates a GPT index including embeddings corresponding to examples to facilitate identification and retrieval of one or more supplemental examples based on an embedding of an input to a generative model. The machine learning training module 240 stores the GPT index including the supplemental examples, or the embeddings for the supplemental examples in various embodiments.

The user profile store 250 includes a user profile corresponding to each user of the task management system 130. A user profile of a user includes a user identifier of a corresponding user, characteristics of the user, contact information for the user, or other descriptive information about the user. In various embodiments, the user profile of the user includes task identifiers of tasks associated with the user. Further, in some embodiments, the user profile of the user includes one or more permissions of the user. One or more permissions included in the user profile of a user identify types of interactions the user is permitted to perform with one or more tasks. Different permissions may correspond to different tasks, allowing the user to perform different types of interactions with different tasks. A user profile may also maintain references to interactions by the corresponding user performed on one or more tasks and stored in an interaction log in the data store 260. This allows the user to review or to identify one or more interactions the user previously performed with tasks.

The data store 260 stores data used by the task management system 130. For example, the data store 260 stores tasks created by a user. In various embodiments, the data store 260 includes a task log that includes a task identifier for each task with corresponding attributes of a task associated with the task identifier. For example, the task log includes a task identifier for a task with attributes of the task associated with the task identifier. As further described above, example attributes of the task include: an identifier of a user to perform the task, a status of the task, a due date for the task, a priority level of the task, a resource allocation (e.g., a budget) for performing the task, one or more comments about the task, or other information relevant to performing an action corresponding to the task.

Additionally, the data store 260 stores an interaction log describing interactions by users with the task management system 130. The interaction log includes entries including a task identifier, a user identifier of a user who performed an interaction, a time when the interaction was performed, and a description of the interaction. The description of the interaction may be a type of the interaction and may include data received through the interaction. For example, an interaction is a comment on a task, and a description of the interaction includes a type indicating a comment and text data comprising the comment. In various embodiments, the interaction log organizes entries chronologically, while in other embodiments, the interaction log may organize entries using other formats.

The data store 260 also stores trained machine learning models trained by the machine learning training module 240. For example, the data store 260 may store the set of parameters for a trained machine learning model on one or more non-transitory, computer-readable media. As another example, the data store 260 stores parameters comprising a previously trained model that the machine learning training module 240 obtained from a third party system 110 or from another source. For example, the data store 260 includes a generative model, such as a large language model (LLM) that the machine learning training module 240 obtained from a third party system 110. The data store 260 may also include one or more examples that a machine learning model, such as a generative model receives as input. The data store 260 uses computer-readable media to store data, and may use databases to organize the stored data.

FIG. 3 is a flowchart for a method for generating a prompt for a generative model based on a user selection of a role associated with a content item, in accordance with some embodiments. Alternative embodiments may include more, fewer, or different steps from those illustrated in FIG. 3, and the steps may be performed in a different order from that illustrated in FIG. 3. These steps may be performed by the task management system 130, or by another online system, in various embodiments. Additionally, each of these steps may be performed automatically by the task management system 130 without human intervention.

The task management system 130 receives 305 a request from a user to create a content item. For example, the task management system 130 receives 305 a request from a user via a client device 100 to create a task. As another example, the task management system 130 receives 305 a request from the user via the client device 100 to create a document. Various other types of content items may be created by the task management system 130 in response to a request. The request includes an identifier of a type of content item to create in some embodiments.

To simplify creation of the content item for the user, the task management system 130 applies one or more generative models, such as large language models (LLMs), to data received from the user. Applying a generative model to data from the user reduces an amount of data for the user to provide to the task management system 130 for creating the content item. In various embodiments, a generative model is a generative pre-trained transformer model (GPT). The generative model generates text in response to receiving a text prompt as input in various embodiments. Alternatively or additionally, the generative model selects or generates an image in response to a text prompt. The generative model may receive various types of input data (e.g., text, audio, video, image, etc.) and generate one or more types of output data (e.g., text, audio, video, image, text, etc.,) based on the input data. Through application to a large text corpus during pre-training, the generative model learns relationships between different portions of text (e.g., words, phrases) and generates text output in response to a text prompt received as input by leveraging the learned relationships in various embodiments. Alternatively, the generative model is applied to one or more different types of data during the pre-training process to learn relationships between different data that is used to generate output data. Obtaining and applying a pre-trained generative model allows the task management system 130 to leverage relationships between different portions of text (or images or other data) that the generative model learned through application to a text corpus (or image corpus or other type of data corpus) including a larger amount of data and more varied data than maintained by the task management system 130.

While applying a generative model to data provided by the user simplifies creation of the content item, data included in the content item is affected by the data included in a prompt to which the generative model is applied. When the user provides limited information to the task management system 130 for creating the content items, the prompt used for generating the content item similarly includes limited information. Having limited information from the user in the prompt causes inclusion or omission of specific data from the prompt causes greater variation in accuracy of the generated content item for the user's purpose. This may subsequently increase computational resources expended by the task management system 130 from user modification of the generated content item to rectify variations between the generated content item and the user's purpose for the content item.

To simplify generation of the prompt to which the generative model is applied and to increase an accuracy of the content item generated in response to the prompt for the user, the task management system 130 receives 310 a selection of a role of the user relative to the content item. In various embodiments, a role specifies a characteristic of users included in an audience viewing the content item, specifies a category of information to include in the content item, or specifies one or more characteristics of the content item. A role may specify another characteristic of the user or another attribute of the content item. Other information may be identified by a role in various embodiments. For example, a role identifies the content item as relating to technical implementation, while another role identifies the content item as relating to marketing or sales. In some embodiments, the task management system 130 receives 310 a selection of a role from a set of roles presented to the user via a creation interface.

The task management system 130 associates each role is associated with one or more templates. Different templates correspond to different types of data included in the content item. Further, different templates include different data in the content item or present data in the content item using different formats. In various embodiments, the task management system 130 stores an identifier of a role and stores associations between the identifier of the role and one or more templates to maintain relationships between templates and the role. In response to receiving 310 the selection of the role from the user, the task management system 130 retrieves 315 a set of templates associated with the selected role and presents 320 identifiers of the set of templates to the user. An identifier of a template may be a name of the template, a description of the template, or other information capable of uniquely identifying a template to the user. However, in some embodiments, the task management system 130 retrieves 315 templates stored by the task management system 130 and presents 320 identifiers of the retrieved template to the user in response to receiving 305 the request to create the content item without receiving 310 a selection of a role from the user.

Each template includes one or more fields. Each field corresponds to a type of data presented by a content item based on the template or corresponds to a type of data relevant to a content item based on the template. For example, a template is a product listing, with different fields associated with the product listing identifying different attributes of a product. As another example, a template is a technical specification, with different fields included in the technical specification identifying different features of a product. In another example, a template is a proposal, with different fields included in the proposal identifying a budget for the proposal, a timeline for the proposal, one or more keywords for the proposal, or other information about the proposal. Various templates include different combinations of fields or different fields.

Additionally, each template includes one or more output formatting instructions that specify a format in which content based on the template is presented. For example, output formatting instructions specify a content item presents data presented as a table and identifies locations within the table for various fields associated with types of content. As another example, output formatting instructions specify paragraph formatting, font formatting, or other visual features of a document, as well as identify positions in the document corresponding to fields associated with the type of content. Example visual features of a content item include: a font, a font size, a font color, spacing between different sections of the content item 450, a background color, a background image, or other visually identifiable features of the content item.

The task management system 130 receives 325 a selection of a template from the user. For example, a user selects an identifier of a template via a creation interface to select the template. In response to receiving 325 the selection of the template, the task management system 130 generates 330 a form including the fields included in the selected template and having an interface element associated with each field. Generating the form to identify fields from the selected template reduces a number of inputs from the user to provide information for generating the content item, while identifying data most relevant to the content item to be generated. The form provides a structured interface for the user to provide the task management system 130 with specific data identified by the form rather to provide unstructured text for generating the content item. This allows the task management system 130 to obtain specific data for optimally generating the content item from the user.

Additionally, the creation interface includes one or more inputs for the user to specify a tone or a creativity level of the content item to be generated based on the values of the fields associated with the selected template. The task management system 130 obtains 340 a tone, or a creativity level, for the content item from a user input to a creation interface or from an interaction by the user with the creation interface in various embodiments. For example, the creation interface presents a tone selection element where a user selects a tone from a group of candidate tones. The tone affects words or phrases included in the generated content item, as well as punctuation conventions used in the generated content items, which affects how other users perceive the generated content item when reviewing. Example tones include: professional, straightforward, optimistic, inspirational, casual, confident, friendly, encouraging, and humorous. Different or additional tones may be maintained by the task management system 130 in various embodiments.

The creativity level specifies an amount of additional information included in the generated content item that is not directly related to the values for one or more fields associated with the selected template. For example, the user selects one of high creativity, medium creativity, and low creativity as the creativity level. High creativity includes a greater amount of additional information other than the values for the fields included in the selected template in the content item, while low creativity includes less additional information other than the values for the fields included in the selected template in the content item.

In some embodiments, the task management system 130 obtains 340 the tone for the content item based at least in part on one or more additional content items associated with the user. For example, the task management system 130 receives a tone from the user and augments the received tone with one or more additional content items created by the user (or otherwise associated with the user). Alternatively, the task management system 130 obtains 340 the tone by selecting additional content items without receiving the tone from the user. Additional content items may also be selected and leveraged to determine the creativity level for the content item. Selecting additional content items that the user created (or otherwise associated with the user) allows the task management system 130 to account for a writing style or preferences of the user when generating the content item, so the generated content item is stylistically and thematically consistent with other content items generated by the user.

For example, to select one or more additional content items, the task management system 130 generates an embedding for the content item being created based on the values for the fields included in the template received 335 from the user and selects additional content items previously created by the user (or associated with the user) having embeddings with at least a threshold measure of similarity (e.g., cosine similarity, dot product) to the embedding for the content item being created. As another example, the task management system 130 selects additional content items previously created by the user and included in a common list or a common workspace as the content item being created, or additional content items having one or more other common attributes with the content item being created.

In some embodiments, the task management system 130 accounts for recency of content items previously created by the user (or otherwise associated with the user) relative to a time when the request to create the content item was received 305 by the task management system 130 when selecting additional content items. This biases selection of additional content items by the task management system towards content items more recently created by the user in various embodiments. For example, the task management system 130 selects content items having one or more attributes matching received values for the fields included in the selected template and created by the user within a threshold amount of time from a time when the task management system 130 received 305 the request to create the content item as additional content items. As another example, the task management system 130 ranks content items previously created by the user based on their recencies relative to the time when the task management system received 305 the request to create the content item, with more recent content items having higher positions in the ranking. In the preceding example, the task management system 130 selects content items having at least a threshold position in the ranking as additional content items. In some embodiments, the task management system 130 maintains one or more example content items associated with the user or associated with an entity associated with the user that the task management system 130 selects as additional content items. Maintaining example content items associated with the user (or with the entity associated with the user) allows the user or the entity associated with the user to specify specific example content items for obtaining 340 the tone (or the creativity level) of the content item.

Based on the values received 335 from the user for the fields included in the selected template received and the tone obtained 340 for the content item (as well as the creativity level, if specified), the task management system 130 generates 345 a prompt for a generative model, such as a large language model (LLM). The prompt includes identifiers of each field included in the selected template and corresponding values for one or more fields received 335 from the user, the tone (including or comprising one or more additional content items previously created by or associated with the user that were selected), and the output formatting instructions included in the selected template (as well as the creativity level of the content item, if specified). The task management system 130 applies the generative model to the generated prompt. Based on the generated prompt and previously learned relationships between portions of text learned during pre-training, the generative model generates a content item.

The generated content item presents the values for the fields associated with the selected template based on the output formatting instructions included in the selected template and the tone (and creativity level) included in the prompt. Including the output formatting instructions in the prompt customizes the format with which the content item presents values for the fields based on the selected template, conserving computational resources expended creating the content item by minimizing subsequent modifications to formatting of the content item in response to received user inputs after generation of the content item. For example, output formatting instructions specify positions for headings in the content item, values of fields included in different headings or included in other locations within the content item, as well as other visual features of the content item. Example visual features of the content item include: a font, a font size, a font color, spacing between different sections of the content item, a background color, a background image, or other visually identifiable features of the content item. Hence, the task management system 130 leverages a template selected 325 by the user to generate 330 a form that prompts the user for values to specific fields associated with the selected template. The form obtains the most relevant data for generating the content item from the user, increasing a likelihood of the generative model generating a content item consistent with a purpose of the content item based on the role of the user relative to the content item. Similarly, the output formatting instructions included in the selected template simplify generation of the content item by reducing a likelihood of the user subsequently reformatting the generated content item.

FIG. 4 is an interaction diagram of one embodiment of a method for generating a prompt for a generative model based on user selection of a role associated with a content item. As further described above in conjunction with FIGS. 2 and 3, a task management system 130 stores different types of content items, such as tasks, data objects, or interactions with tasks. Additionally, the task management system 130 allows a user 400 to create content items that are maintained by the task management system 130, or may be distributed to other sources (e.g., a third party system 110). The task management system 130 receives a request 405 from a client device 100 of the user to create a content item, and transmits one or more interfaces to the client device 100 for presentation to the user 400. In some embodiments, the request 405 specifies a type of the content item to be created. Example types of a content item include: a document, a task, or another data object. The request 405 includes an identifier of the user 400 in various embodiments.

To simplify creation of the content item, the task management system 130 applies one or more generative models, such as large language models (LLMs), to data received from the user subsequent to the request 405 to create the content item. Using one or more generative models allows the task management system 130 to reduce an amount of data the user 400 provides the task management system 130 to create the content item. In various embodiments, a generative model is a generative pre-trained transformer model (GPT). The generative model generates text in response to a text prompt in various embodiments. During a pre-training process, the generative model is applied to a large text corpus to learn relationships between different portions of text (e.g., words, phrases) and leverages the learned relationships to generate text output in response to receiving a text prompt as input. Hence, applying a pre-trained generative model to a prompt including text received from the user 400 leverages relationships between different text (or images) the generative model learned through application to a text corpus (or image corpus) including a larger amount of data and more varied data than maintained by the task management system 130 to generate the content item based on limited text data from the user 400.

While applying a generative model to data provided by the user 400 simplifies content item creation for the user 400, data from the user 400 included in a prompt to which the generative model is applied affects the content of the resulting content item. Inclusion or omission of specific information from the prompt affects the accuracy of the generated content item for the user's purpose. Variations between the generated content item and the user's purpose are more likely to occur when the user 400 provides limited data for creating the content item to the task management system 130.

To simplify generation of the prompt to which the generative model is applied and to increase an accuracy of the content item generated by the generative model for the user 400, the task management system 130 receives a selection of a role 410 of the user 400 relative to the content item. In various embodiments, a role 410 specifies a characteristic of an audience of users viewing the content item or specifies a category of information included in the content item. Other information may be identified by the role 410 in various embodiments. For example, a role 410 identifies the content item as relating to technical implementation, while another role 410 identifies the content item as relating to marketing or sales. In some embodiments, the task management system 130 receives a selection of a role 410 from a set of roles presented to the user 400 via a creation interface. Different sets of roles may be associated with different users, so the user 400 may be presented with a different set of roles than another user.

The task management system 130 associates each role 410 with one or more templates 420. Different templates 420 correspond to different types of data included in the content item. Further, different templates 420 cause different data to be included in the content item or cause the content item to present data in different formats. In various embodiments, the task management system 130 stores an identifier of a role 410 and stores associations between the identifier of the role 410 and one or more templates 420 to maintain relationships between templates 420 and roles 410. In response to receiving the role 410 from the user 400, the task management system 130 retrieves a set of templates 420 associated with the role 410 and presents identifiers of different templates 420 of the set of templates to the user 400. An identifier of a template may be a name of the template, a description of the template, or other information capable of uniquely identifying a template to the user. However, in some embodiments, the task management system 130 retrieves templates 420 stored by the task management system 130 and presents corresponding identifiers of the templates 420 in response to receiving the request 405 to create the content item without receiving a selection of a role 410 from the user 400.

Each template includes one or more fields. Each field corresponds to a type of data presented by a content item based on the template or corresponds to a type of data relevant to the content item based on the template. For example, a template is a product listing, with different fields associated with the product listing identifying different attributes of a product. As another example, a template is a technical specification, with different fields associated with the technical specification identifying different features of a product. In another example, a template is a proposal, with different fields associated with the proposal identifying a budget for the proposal, a timeline for the proposal, one or more keywords for the proposal, or other information about the proposal.

Additionally, each template includes one more output formatting instructions. The output formatting instructions specify a format in which content based on the template is presented. In various embodiments, outputting instructions specify one or more formats in which values for fields included in the template are displayed by a content item based on the template. For example, output formatting instructions specify a content item presents data as a table, and identifies fields associated with the type of content associated with different locations within the table. As another example, output formatting instructions specify paragraph formatting, font formatting, or other visual features of a document, as well as identify positions in the document corresponding to fields associated with the type of content.

The task management system 130 receives a selection of a template from the user 400. For example, a user 400 selects an identifier of a template to select the template via a creation interface. In response to receiving the selection of the template from the user 400, the task management system 130 generates a form 430 including the fields included in the selected template 425 and having an interface element associated with each field. Generating the form 430 based on the selected template 425 allows the task management system 130 to reduce a number of inputs from the user 400 to provide information for generating the content item. The form 430 provides the user 400 with a structured interface that identifies specific data via the fields for optimally generating the content item, rather than have the user 400 provide unstructured text for the content item to the task management system 130.

Additionally, the creation interface includes one or more inputs for the user to specify a tone or a creativity level of the content item based on the values of the fields associated with the selected type of content. In various embodiments, the form 430 includes fields for a tone or for a creativity level of the content item. In other embodiments, the task management system 130 obtains the tone or the creativity level for the content item from a user input to a creation interface or from an interaction by the user with the creation interface in various embodiments. For example, the creation interface presents a tone selection element where the user 400 selects a tone from a group of candidate tones. The tone affects words or phrases included in generated content, as well as punctuation in generated content, influencing how other users perceive the generated content item. Example tones include: professional, straightforward, optimistic, inspirational, casual, confident, friendly, encouraging, and humorous. However, other tones with corresponding criteria for word selection and punctuation selection for the content item may be maintained by the task management system 130.

The creativity level specifies an amount of additional information that is not directly related to the values for the fields included in the selected template 425 that the generative model includes in the content item. In various embodiments, the user selects the creativity level from a set of creativity levels. For example, the user selects 400 one of high creativity, medium creativity, and low creativity as the creativity level. High creativity includes a greater amount of additional information other than the values for the fields from the selected template 425 in the content item, while low creativity includes less additional information other than the values for the fields included in the selected template 425 in the content item.

In some embodiments, the task management system 130 obtains the tone for the content item based at least in part on one or more additional content items associated with the user 400. For example, the task management system 130 receives a tone from the user 400 and augments the received tone with one or more additional content items created by the user 400 (or otherwise associated with the user). Alternatively, the task management system 130 obtains the tone by selecting additional content items rather than receiving the tone from the user 400. Additional content items may similarly be leveraged to determine the creativity level for the content item. Selecting additional content items that the user 400 created (or otherwise associated with the user) allows the task management system 130 to account for a writing style or preferences of the user 400 when generating the content item. For example, the task management system 130 generates an embedding for the content item being created based on the values for the fields included in the template 425 received via the form 430 and selects additional content items previously created by the user 400 that have embeddings with at least a threshold measure of similarity (e.g., cosine similarity, dot product) to the embedding for the content item being created. Selecting additional content items created by the user 400 allows the generated content item to appear stylistically and thematically consistent with other content items generated by the user 400.

In some embodiments, the task management system 130 accounts for the recency of content items previously created by the user 400 when selecting additional content items. This biases selection of additional content items towards content items more recently created by the user 400 in various embodiments. For example, the task management system 130 selects content items having one or more attributes matching attributes from the values for the fields included in the selected template 425 received via the form 430 and that were created by the user 400 within a threshold amount of time from a time when the task management system 130 received the request 405 to create the content item. As another example, the task management system 130 ranks content items previously created by the user 400 based on their recency relative to the item when the task management system 130 received the request 405 to create the content item, with more recent content items having higher positions in the ranking, and selects content items having at least a threshold position in the ranking. In some embodiments, the task management system 130 maintains one or more example content items associated with the user 400 or associated with an entity associated with the user that the task management system 130 selects as additional content items. Maintaining the example content items allows the user 400 or the entity associated with the user to specify specific content items for obtaining the tone (or the creativity level) of the content item.

Based on the values for the fields included in the selected template 425 that the task management system 130 received via the form 430 and the tone for the content item (as well as the creativity level, if specified), the task management system 130 generates a prompt 440 for a generative model 445, such as a large language model (LLM). The prompt 440 includes identifiers of each field included in the selected template and a corresponding value for each field received from the user, the tone (including one or more additional content items previously created by or associated with the user that were selected), and the output formatting instructions included in the selected template 425, as well as the creativity level of the content item, if specified. For example the prompt 440 includes a name (or other identifier) of a field from the selected template 425 in conjunction with a value for the field from the form 430, includes the output formatting instructions from the selected template 425, and includes the tone for the content item (and includes the creativity level for the content item, if specified). The task management system 130 applies the generative model 445 to the prompt 440, which generates a content item 450 based on the prompt 440 and relationships between portions of text that the generative model 445 learned through a pre-training process, as further described above in conjunction with FIGS. 2 and 3.

The generated content item 450 presents the values for the fields associated with the selected template 425 received via the form 430 based on the output formatting instructions included in the selected template 425 and the tone (and creativity level) included in the prompt. Including the output formatting instructions in the prompt 440 customizes the format with which the content item 450 presents values for the fields based on the selected template 425, minimizing subsequent modifications to formatting of the content item 450 by the user 400 for subsequent use and conserving computational resources subsequently used for modifying the content item 450 based on user inputs after generation of the content item 450. For example, the output formatting instructions specify positions for headings in the content item 450, positions for values of fields in different headings or in other locations within the content item 450, as well as other visual features of the content item 450. Example visual features of the content item 450 include: a font, a font size, a font color, spacing between different sections of the content item 450, a background color, a background image, or other visually identifiable features of the content item.

Hence, the task management system 130 leverages the selected template 425 to generate a form 430 prompting the user 400 for values to specific fields associated with the selected template 425. The form 430 identifies different fields to the user 400 to identify the most relevant information for generating a content item. Similarly, output formatting instructions included in the selected template 425 allow the task management system 130 to further simplify generation of the content item 450 by reducing a likelihood of the user subsequently reformatting a content item 450 generated by the generative model 445 based on the received values for the specific fields in the selected template 425 and the output formatting instructions included in the selected template 425.

The embodiments described herein provide technical improvements to the functionality of computer systems and to machine learning techniques. In particular, the described embodiments leverage information from a user identifying a role of the user relative to a content item to be generated by the computer system (e.g., a task management system). Based on the role, the computer system generates a form for the user that includes specific fields corresponding to the role. Values that the online system receives for the fields are subsequently used by the computer system to generate a prompt for a generative model, such as a large language model, that automatically generates the content item for the user based on the values received from the fields. By leveraging the role for the user to generate a form for presentation to the user, the computer system simplifies data acquisition by identifying specific fields for inclusion in a content item the computer system generates for the user. Having the form generated based on the role include role-specific fields simplifies generation of a prompt for the generative model by obtaining values for fields via the form that the computer system previously determined to be relevant to the role specified by the user. This simplifies generation of the prompt used by the generative model to generate the content item, decreasing an amount of computing resources subsequently used for modification of the content item by the user or used for iterative application of the generative model to different prompts to iteratively edit or modify a generated content item.

### ADDITIONAL CONSIDERATIONS

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated for the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a task management system comprising a processor and a non-transitory computer readable medium, comprising:
receiving, at the task management system, a request to create a content item from a user;
receiving a selection of a role of the user for the content item from the user;
retrieving a set of templates associated with the role of the user maintained by the task management system;
receiving, at the task management system, a selection of a template of the set of templates from the user, each template including one or more fields and output formatting instructions specifying a format in which a content item based on the template presents data;
generating, by the task management system, a form including fields included in the selected template;
receiving, at the task management system, a value for one or more of the fields included in the selected template in response to presenting the form to the user;
obtaining a tone of the content item at the task management system; and
generating, at the task management system, a prompt for a generative model that identifies each field included in the selected template, the values received for one or more fields included in the selected template, the tone of the content item, and the formatting instructions included in the selected template.

2. The method of claim 1, further comprising:
generating the content item by applying the generative model to the prompt, the content item including the values received for one or more fields included in the selected template and presenting values subject to the formatting instructions included in the selected template.

3. The method of claim 1, wherein obtaining the tone of the content item at the task management system comprises:
selecting one or more additional content items previously created by the user and maintained by the task management system.

4. The method of claim 3, wherein selecting one or more additional content items previously created by the user and maintained by the task management system comprises:
selecting one or more additional content items previously created by the user having embeddings with at least a threshold measure of similarity to an embedding of the content item based on the one or more fields included in the selected template and values for one or more of the fields included in the selected template.

5. The method of claim 3, wherein selecting one or more additional content items previously created by the user and maintained by the task management system comprises:
selecting one or more additional content items included in a common list as the content item.

6. The method of claim 5, wherein selecting one or more additional content items included in the common list as the content item comprises:
selecting one or more additional content items included in the common list as the content item and that were created within a threshold amount of time of a time when the task management system received the request to create the content item.

7. The method of claim 5, wherein selecting one or more additional content items included in the common list as the content item comprises:
selecting one or more additional content items included in the common list as the content item and that have at least a threshold position in a ranking of content items previously created by the user based on corresponding recencies when the user created the content items.

8. The method of claim 1, wherein obtaining the tone of the content item at the task management system comprises:
receiving the tone from the user.

9. The method of claim 1, wherein obtaining the tone of the content item at the task management system comprises:
receiving the tone from the user and selecting one or more additional content items previously created by the user and maintained by the task management system.

10. The method of claim 1, wherein obtaining the tone of the content item at the task management system comprises:
receiving an input from the user specifying the tone; and
receiving a creativity level for the content item from the user.

11. A computer program product comprising a non-transitory computer readable storage medium having instructions encoded thereon that, when executed by a processor, cause the processor to perform steps comprising:
receiving, at a task management system, a request to create a content item from a user;
receiving a selection of a role of the user for the content item from the user;
retrieving a set of templates associated with the role of the user maintained by the task management system;
receiving, at the task management system, a selection of a template of the set of templates from the user, each template including one or more fields and output formatting instructions specifying a format in which a content item based on the template presents data;
generating, by the task management system, a form including fields included in the selected template;
receiving, at the task management system, a value for one or more of the fields included in the selected template in response to presenting the form to the user;
obtaining a tone of the content item at the task management system; and
generating, at the task management system, a prompt for a generative model that identifies each field included in the selected template, the values received for one or more fields included in the selected template, the tone of the content item, and the formatting instructions included in the selected template.

12. The computer program product of claim 11, wherein the non-transitory computer readable storage medium further has instructions encoded thereon that, when executed by the processor, cause the processor to perform steps comprising:
generating the content item by applying the generative model to the prompt, the content item including the values received for one or more fields included in the selected template and presenting values subject to the formatting instructions included in the selected template.

13. The computer program product of claim 11, wherein obtaining the tone of the content item at the task management system comprises:
selecting one or more additional content items previously created by the user and maintained by the task management system.

14. The computer program product of claim 13, wherein selecting one or more additional content items previously created by the user and maintained by the task management system comprises:
selecting one or more additional content items previously created by the user having embeddings with at least a threshold measure of similarity to an embedding of the content item based on the one or more fields included in the selected template and values for one or more of the fields included in the selected template.

15. The computer program product of claim 13, wherein selecting one or more additional content items previously created by the user and maintained by the task management system comprises:
selecting one or more additional content items included in a common list as the content item.

16. The computer program product of claim 15, wherein selecting one or more additional content items included in the common list as the content item comprises:
selecting one or more additional content items included in the common list as the content item and that were created within a threshold amount of time of a time when the task management system received the request to create the content item.

17. The computer program product of claim 15, wherein selecting one or more additional content items included in the common list as the content item comprises:
selecting one or more additional content items included in the common list as the content item and that have at least a threshold position in a ranking of content items previously created by the user based on corresponding recencies when the user created the content items.

18. The computer program product of claim 11, wherein obtaining the tone of the content item at the task management system comprises:
receiving the tone from the user.

19. The computer program product of claim 11, wherein obtaining the tone of the content item at the task management system comprises:
receiving the tone from the user and selecting one or more additional content items previously created by the user and maintained by the task management system.

20. The computer program product of claim 11, wherein obtaining the tone of the content item at the task management system comprises:
receiving an input from the user specifying the tone; and
receiving a creativity level for the content item from the user.
